(19) United States
(12) Patent Application Publication
(10) Pub. No.: US 2010/0284023 A1
(43) Pub. Date: Nov. 11, 2010

(54) DEVICE AND METHOD FOR MEASURING THE SHAPE OF FREEFORM SURFACES

(76) Inventors: Matthias Fleischer, Ostfildern (DE); Pawel Drabarek, Tiefenbronn (DE); Ralf Kochendoerfer, Leonberg (DE)

Correspondence Address: KENYON & KENYON LLP, ONE BROADWAY, NEW YORK, NY, 10004, US

(21) Appl. No.: 12/451,491

(22) PCT Filed: Apr. 9, 2008
(86) PCT No.: PCT/EP2008/054283

§ 371 Date: Mar. 9, 2010

(30) Foreign Application Priority Data
May 24, 2007 (DE) 10-2007-024-197.8

(51) Int. Cl. G01B 11/24

(52) U.S. Cl. 356/511

(57) ABSTRACT

A device for measuring the shape of freeform surfaces of objects includes a point-measuring optical and or interferometric scanning arm which is displaceable along a predefined path line, which device generates a measurement beam focused on the freeform surface to be measured. With reference to the scanning point, the scanning arm is able to rotate in at least one plane, in such a way that the measuring beam impinges upon the freeform surface to be measured in a perpendicular manner or within an acceptance angle of the scanning arm.

### BACKGROUND OF THE INVENTION

1. Field of the Invention

The present invention relates to a device and a method for measuring the shape of freeform surfaces of objects to be measured, having a point-measuring optical and/or interferometric scanning arm which is displaceable along a predefined path line, having a measurement beam focused on the freeform surface to be measured.

2. Description of Related Art

An interferometric measuring device is known from published German patent document DE 198 08 273, which device is for recording the shape of rough surfaces, a spatially coherent beam generating unit being provided, which emits a temporally short-coherent and broadband radiation, and a separation into a section having the components of a measuring probe being performed, and the measuring probe is connected to the modulating interferometer via a light-conducting fiber device, and is able to be used at a distance from the modulating interferometer.

Such interferometric measuring devices are used in shape-measuring machines. The measuring probe is integrated into an optical scanning arm which is mechanically connected replaceably to a measuring machine, for instance, via a magnetic coupling. The modulating interferometer, as a component of the optical measuring unit is also linked to the measuring machine. The optical connection between the optical measuring unit and the measuring probe takes place via the light-conducting fiber device.

Known shape measuring machines having point-measuring scanning arms use systems that move the scanning arm scanning point along a path line. An optical or interferometric scanning arm has no limited acceptance angle, however, which limits the admissible variation of the surface inclination of the surface to be measured. Consequently, using such a device, basically only cylindrical, conic or flat surfaces are able to be measured. The measurement, for example, of spherical, rotationally symmetrical or aspherical surfaces is not possible, since, beginning at a certain inclination of the surface to the optical axis of the scanning arm, the admissible acceptance angle is exceeded.

Furthermore, surface measuring optical systems are known, for instance in the form of white light interferometers. Such systems require objectives which generate light wave fronts adapted to the surface to be measured. The objectives for freeform surfaces have great complexity and are correspondingly expensive.

### BRIEF SUMMARY OF THE INVENTION

It is therefore an object of the present invention to create a device which makes possible the optical measurement of any freeform surfaces having point-shaped measuring scanning arms.

A further object of the present invention is to make available a corresponding method for this.

The object of the present invention relating to the device is attained in that, with reference to its scanning point, the scanning arm is able to rotate, in at least one plane, in such a way that the measuring beam impinges upon the freeform surface to be measured in a perpendicular manner or within an acceptance angle of the scanning arm. Superposed with the predefined path motion of the scanning arm, the scanning arm is able to be moved over the freeform surfaces, the angle between the surface normals of the surface to be measured at the scanning point and the optical axis of the scanning arm over the rotating motion of the scanning arm being able to be set in such a way that the acceptance angle predefined by the scanning arm, within which a measurement is possible, is not exceeded. In this context, the best measuring results are achieved when the measuring beam impinges on the surface to be measured in a perpendicular manner, or at least approximately perpendicular.

If the scanning arm is only rotatable in a plane about its scanning point, and if the path motion is also in this plane, this yields a simple construction of the device, which, however, first of all measures only along a line. If, however, the scanning arm is rotatable in two planes that stand perpendicular to each other, and if a corresponding path motion is also provided, two-dimensional surfaces may also be measured.

If it is provided that the object to be measured is rotatable, then using one scanning arm, which is only rotatable in one plane about its scanning point, and whose path motion is in this plane, a two-dimensional form surface is able to be picked up by appropriately rotating the object to be measured, and consequently, the freeform surface. This makes possible the measuring of a sphere, for example, by having the scanning arm aligned to one point of the spherical surface, the spherical surface being moved by the rotational motion of the sphere through the scanning point, and thus the spherical surface being scanned in linear form.

According to one example embodiment of the present invention, it is provided that the scanning arm is a part of the interferometric measuring device, the scanning arm being connected to a modulating interferometer via a light-conducting fiber device. The interferometric measuring device makes possible the optical measuring of the surface of the test object. The light-conducting fiber device, in this instance, permits the free motion of the scanning arm along a path line, as well as the rotation of the scanning arm about the scanning point.

The object of the present invention, relating to the method, is attained in that the scanning arm is rotated with reference to its scanning point, perpendicular to the optical axis of the scanning arm in at least one plane, and in that the rotation of the scanning arm with reference to its scanning point is achieved by a rotational motion of the scanning arm perpendicular to the optical axis of the scanning arm at a simultaneous motion of the scanning arm along the path line. Because of this superposed motion sequence, the scanning is able to be aligned to a provided point of the freeform surface while maintaining a favorable scanning angle.

### BRIEF DESCRIPTION OF THE SEVERAL VIEWS OF THE DRAWING

FIG. 1 shows the motion of a scanning arm for measuring a first freeform surface, in a graphic representation.

FIG. 2 shows the motion of a scanning arm for measuring a second freeform surface, in a graphic representation.

### DETAILED DESCRIPTION OF THE INVENTION

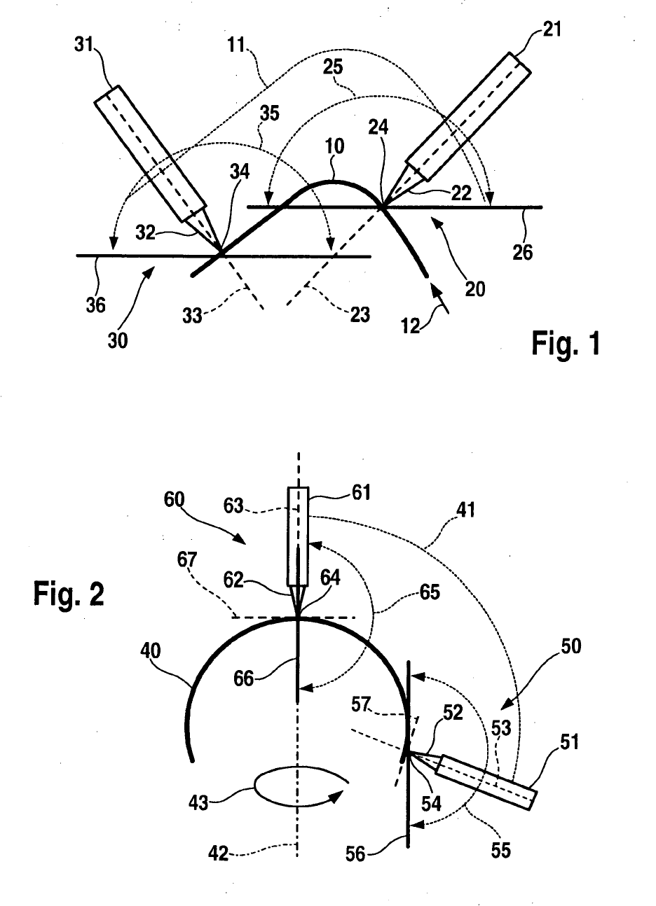

FIG. 1 shows the motion of a scanning arm 21, 31 for measuring a first freeform surface 10, in a graphic representation.

Scanning arm 21, 31 is shown in a first measuring position 20 and in a second measuring position 30.

For first measuring position 20, position 21, an optical axis position 23 and a measuring beam position 22 are assigned to the scanning arm. In a corresponding manner, for second measuring position 30, position 31, an optical axis position 33 and a measuring beam position 32 are assigned to the scanning arm.

In a respectively appertaining scanning point position 24 and scanning point position 34, measuring beam position 22 and measuring beam position 32 are focused on first freeform surface 10.

A path line 11 specifies the motion of scanning arm 21, 31, that is adapted to first freeform surface 10, along which scanning arm 21, 31 gets from first measuring position 20 to second measuring position 30.

A rotational angle 25 symbolizes the possible rotational motion of scanning arm position 21 in first measuring position 20, while a rotational angle 35 shows the possible rotational motion of scanning arm position 31 in second measuring position 30. In the exemplary embodiment, the rotational motion is limited to 180°, which is shown by angular boundary line position 26 and angular boundary line position 36.

A direction of motion 12 specifies the travel path of scanning point 24, 34 over first freeform surface 10.

For the optical measurement of the surface of first freeform surface 10, scanning arm 21, 31 is moved along first path line 10 in such a way that scanning point 24, 34 is moved via freeform surface 10. Path line 10 is selected, in this context, so that measuring beam 22, 32 always focuses on first freeform surface 10.

It is provided, according to the present invention, that scanning arm 21, 31 is able to be rotated corresponding to rotational angle position 25 and rotational angle position 35 shown, about respective scanning point position 23 and scanning point position 33. It is thereby made possible that optical axis 23, 33 of scanning arm 21, 31 is able to be aligned approximately perpendicularly to freeform surface 10. Measuring beam 22, 32 thus always impinges upon first freeform surface 10, within an acceptance angle specified by scanning arm 21, 31.

Rotational motion and motion along first path line 11 are superposed, in this context, in such a way that scanning point 24, 34 is guided at a favorable angle of optical axis 23, 33 of scanning arm 21, 31 over first freeform surface 10, corresponding to direction of motion 12 shown. This makes it possible to ascertain the deviation in shape of first freeform surface 10 from a setpoint contour, the surface inclination of first freeform surface 10 being able to change in almost any fashion without the acceptance angle of scanning arm 21, 31 being exceeded.

FIG. 2 shows the motion of a scanning arm 51, 61 for measuring a second freeform surface 40, in a graphic representation.

Scanning arm 51, 61 is shown in a third measuring position 50 and a fourth measuring position 60.

Analogously to the illustration in FIG. 1, in this case, in third measuring position 50, position 51, an optical axis position 53, a measuring beam position 52 and a scanning point position 54 are assigned to the scanning arm. A rotational angle position 55 specifies the possible rotation of scanning arm position 51 about scanning point position 54, so as to set an optimal angle between optical axis position 53 and second and second freeform surface 40. The alignment of the surface of second freeform surface 40 is characterized by a tangent 57. Rotational angle position 55 is limited to 180°, corresponding to angular boundary line position 56.

In fourth measuring position 60, scanning arm position 61 is aligned in such a way that its optical axis position 63 is aligned approximately perpendicular to the surface of second freeform surface 40, shown by a corresponding tangent position 67. An angle of rotation position 65 reproduces the rotational motion of scanning arm position 61, possible for this, about its scanning point position 64. In the embodiment variant shown, the alignment of scanning arm position 61 is shown in its maximum excursion, so that optical axis position 63 and an angular boundary position 66 lie one over the other in congruent fashion.

Scanning arm 51, 61 is able to be moved along a second path line 41, that is adapted to second freeform surface 40, in such a way that scanning point 54, 64 is guided over second freeform surface 40. In this instance, by a simultaneous rotational motion of scanning arm 51, 61 about scanning point 54, 64, optical axis 53, 63 of scanning arm 51, 61 is able to be set so that measuring beam 52, 62 impinges approximately perpendicularly on second freeform surface 40, at least within the acceptance angle specified by scanning arm 51, 61.

In the exemplary embodiment, second freeform surface 40 is developed as a surface of a sphere. It is provided that the sphere be able to exert a rotational motion about a rotational axis 42, according to a rotational motion 43 shown. This arrangement makes it possible to measure rotationally symmetrical components, using a device which only permits the motion of scanning arm 51, 61 in one plane of motion. For this purpose, for instance, in third measuring position 50 of scanning arm position 51, the sphere is rotated about rotational axis 42 by 360° and the surface is measured. Subsequently, scanning point position 54 is displaced by a motion of scanning arm position 51 along second path line 41, in the direction of fourth measuring position 60, the optimal angle between optical axis 53, 63 of scanning arm 51, 61 and the surface of the sphere being set by an appropriate rotational motion of scanning arm 51, 61.

In this new position, the sphere may be rotated again by 360°, and the surface may be correspondingly measured. The process is repeated until fourth measuring position 60 is reached.

By joining together the measuring lines thus obtained, a complete portrayal of the two-dimensional surface of the sphere may be obtained, for instance, having the roughness of the surface of the sphere as the third dimension.

Corresponding to the exemplary embodiment shown, any number of additional rotationally symmetrical freeform surfaces 40 may be measured, for example having aspherical geometries. In the process, the roughness of the surface or the deviation from a specified contour, for example, may be ascertained over entire freeform surface 40.

1-4. (canceled)

5. A device for measuring the shape of at least one freeform surface of a target object, comprising:
a point-measuring scanning arm, wherein:
the scanning arm is at least one of optical and interferometric scanning arm configured to be displaceable along a predefined path line;
the scanning arm generates a measuring beam focused on the freeform surface to be measured;
the scanning arm is configured to be rotated, with reference to a selected scanning point, in at least one plane in such a way that the measuring beam impinges upon the freeform surface to be measured, in one of a perpendicular manner or within an acceptance angle of the scanning arm.

6. The device as recited in claim 5, wherein the target object to be measured is rotatable.

7. The device as recited in claim 5, wherein the scanning arm is a part of an interferometric measuring device, and wherein the scanning arm is connected to a modulating interferometer by a light-conducting fiber device.

8. A method for measuring the shape of at least one freeform surface of a target object, comprising:
providing a point-measuring scanning arm, wherein the scanning arm is at least one of optical and interferometric scanning arm configured to be displaceable along a predefined path line; and
rotating the scanning arm, with reference to a selected scanning point, perpendicular to the optical axis of the scanning arm in at least one plane, wherein the rotation of the scanning arm with reference to the selected scanning point is achieved by a rotational motion of the scanning arm during a simultaneous motion of the scanning arm along the path line.
